(19) United States
(12) Patent Application Publication
(10) Pub. No.: US 2026/0157420 A1
(43) Pub. Date: Jun. 11, 2026

(54) METHODS FOR MODIFYING SENSORY ATTRIBUTES OF AN AEROSOL-FORMING SUBSTRATE

(71) Applicant: Altria Client Services LLC, Richmond, VA (US)

(72) Inventors: Dong QI, Henrico, VA (US); Marilia G Della VECCHIA, Midlothian, VA (US); Ancheng ZHOU, Midlothian, VA (US); Yanxin SHEN, Henrico, VA (US); Shuzhong ZHUANG, Glen Allen, VA (US); Raymond W. LAU, Glen Allen, VA (US)

(73) Assignee: Altria Client Services LLC, Richmond, VA (US)

(21) Appl. No.: 19/409,000

(22) Filed: Dec. 4, 2025

Related U.S. Application Data
(60) Provisional application No. 63/728,770, filed on Dec. 6, 2024.

(51) Int. Cl. A24B 15/30; A24B 9/00; A24B 15/167

(52) U.S. Cl. CPC A24B 15/303; A24B 9/00; A24B 15/167

(57) ABSTRACT

A method for modifying sensory attributes of an aerosol-forming substrate includes contacting a dry powder and a scenting material for a desired time period. The dry powder may have a moisture content of greater than or equal to about 6% to less than or equal to about 12%. The scenting material may include a natural scenting source that includes fresh materials, cured or dried materials, or a combination of fresh materials and cured or dried materials. The contacting may include layering the dry powder and the scenting material for the desired time period, blending together the dry powder and the scenting material for the desired time period, disposing at least one of the dry power and the scenting material in a permeable bag, or any combination thereof.

### CROSS-REFERENCE TO RELATED APPLICATION

This application claims the benefit of U.S. Provisional Application No. 63/728,770, filed on Dec. 6, 2024. The entire disclosure of the above application is incorporated herein by reference.

### BACKGROUND

### Field

The present disclosure relates to aerosol-generating substrates and capsules including the same, such as for use in heated tobacco or heated tobacco product aerosol-generating devices that are configured to generate an aerosol without involving a substantial pyrolysis of the aerosol-forming substrates.

### Description of Related Art

Some electronic devices are configured to heat an aerosol-forming substrate, such as a plant material, to a temperature that is sufficient to release constituents of the plant material while keeping the temperature below a combustion point of the plant material so as to avoid any substantial pyrolysis of the plant material. Such devices may be referred to as aerosol-generating devices (e.g., heated tobacco or heated tobacco product aerosol-generating devices), and the plant material heated may be tobacco and/or Cannabis. In some instances, the plant material may be introduced directly into a heating chamber of an aerosol-generating device. In other instances, the plant material may be pre-packaged in individual containers to facilitate insertion and removal from an aerosol-generating device.

### SUMMARY

At least some example embodiments relate to a method for modifying sensory attributes of an aerosol-forming substrate.

In at least one example embodiment, the method may include contacting a dry powder and a scenting material for a desired time period.

In at least one example embodiment, a mass ratio of the dry powder to the scenting material is greater than or equal to about 2:1 to less than or equal to about 1:2.

In at least one example embodiment, the scenting material may include mint, citrus, ginger root, cinnamon granules, vanilla beans, clove, anise, or any combination thereof.

In at least one example embodiment, the dry powder may have a moisture content less than or equal to about 12%.

In at least one example embodiment, the moisture content of the dry powder may be greater than or equal to about 6%.

In at least one example embodiment, the scenting material may include a fresh material, and the scenting material may have a moisture content greater than or equal to about 60% to less than or equal to about 80%.

In at least one example embodiment, the fresh material may include mint, citrus, ginger root, or any combination thereof.

In at least one example embodiment, the desired time period may be less than or equal to about 120 hours.

In at least one example embodiment, the desired time period may be about 48 hours.

In at least one example embodiment, the contacting of the dry powder and the scenting material may occur at a temperature greater than or equal to about 20° C. to less than or equal to about 22° C.

In at least one example embodiment, the contacting of the dry powder and the scenting material may occur at a temperature less than or equal to about 30° C.

In at least one example embodiment, the scenting material may include a cured material, and the scenting material may have a moisture content less than or equal to about 15%.

In at least one example embodiment, the cured material may include cinnamon granules, vanilla beans, dried mint, clove, anise, or any combination thereof.

In at least one example embodiment, the desired time period may be greater than or equal to about 96 hours to less than or equal to about 120 hours.

In at least one example embodiment, the contacting of the dry powder and the scenting material may occur at a temperature of greater than or equal to about 20° C. to less than or equal to about 40° C.

In at least one example embodiment, the scenting material may include a natural scent source.

In at least one example embodiment, the natural scent source may include mint leaves, vanilla pod, cinnamon granules, or any combination thereof.

In at least one example embodiment, the contacting of the dry powder and the scenting material may include forming a layered structure. The layered structure may include a scenting material layer between first and second dry powder layers. The scenting material layer may include the scenting material. Each of the first and second dry powder layers may include the dry powder.

In at least one example embodiment, the scenting material layer may have an average thickness greater than or equal to about 5 millimeters to less than or equal to about 10 millimeters.

In at least one example embodiment, at least one of the first and second dry powder layers may have an average thickness greater than or equal to about 5 millimeters to less than or equal to about 10 millimeters.

In at least one example embodiment, each of the first and second dry powder layers may have an individual average thickness greater than or equal to about 5 millimeters to less than or equal to about 10 millimeters.

In at least one example embodiment, the contacting of the dry powder and the scenting material may include blending together the dry powder and the scenting material.

In at least one example embodiment, the contacting of the dry powder and the scenting material may include disposing at least one of the dry powder and the scenting material in a permeable bag.

In at least one example embodiment, the scenting material may include mint leaves, cinnamon granules, or a combination of mint leaves and cinnamon granules.

In at least one example embodiment, the contacting of the dry powder and the scenting material may include adjusting temperature, pressure, humidity, or any combination thereof of the dry powder, the scenting material, or a combination of the dry powder and the scenting material.

In at least one example embodiment, the method may further include separating the scenting material and the dry powder.

In at least one example embodiment, the separating of the scenting material and the dry powder may include sifting the dry powder.

In at least one example embodiment, the method may further include drying the dry powder such that the dry powder has a moisture content of less than or equal to about 15%.

In at least one example embodiment, the contacting of the dry powder and the scenting material may be a first contacting, the scenting material may be a first scenting material, the desired time period may be a first desired time period, and the method may further include second contacting the dry powder and a second scenting material for a second desired time period.

In at least one example embodiment, between the first contacting and the second contacting, the method may further include drying the dry powder to have a moisture content of less than or equal to about 30%.

In at least one example embodiment, the second scenting material may be the same as the first scenting material.

In at least one example embodiment, the second scenting material may be different from the first scenting material.

In at least one example embodiment, the second desired time period may be the same as the first desired time period.

In at least one example embodiment, the second desired time period may be different from the first desired time period.

In at least one example embodiment, the dry powder may include tobacco.

At least some example embodiments relate to a method for modifying sensory attributes of an aerosol-forming substrate.

In at least one example embodiment, the method may include contacting a dry powder and a scenting material for a desired time period.

In at least one example embodiment, the scenting material may include mint, citrus, ginger root, cinnamon granules, vanilla beans, clove, anise, or any combination thereof.

In at least one example embodiment, a mass ratio of the dry powder to the scenting material may be greater than or equal to about 2:1 to less than or equal to about 1:2.

In at least one example embodiment, the dry powder may have a moisture content greater than or equal to about 6% to less than or equal to about 12%.

In at least one example embodiment, the scenting material may include a fresh material, and the scenting material may have a moisture content greater than or equal to about 60% to less than or equal to about 80%.

In at least one example embodiment, the fresh material may include mint, citrus, ginger root, or any combination thereof.

In at least one example embodiment, the contacting of the dry powder and the scenting material may occur at a temperature greater than or equal to about 20° C. to less than or equal to about 30° C.

In at least one example embodiment, the scenting material may include a cured material, and the scenting material may have a moisture content less than or equal to about 15%.

In at least one example embodiment, the desired time period may be greater than or equal to about 96 hours to less than or equal to about 120 hours.

In at least one example embodiment, the contacting of the dry powder and the scenting material may occur at a temperature of greater than or equal to about 20° C. to less than or equal to about 40° C.

In at least one example embodiment, the scenting material may include a natural scent source.

In at least one example embodiment, the contacting of the dry powder and the scenting material may include forming a layered structure. The layered structure may include a scenting material layer between first and second dry powder layers. The scenting material layer includes the scenting material. Each of the first and second dry powder layers may include the dry powder.

In at least one example embodiment, the scenting material layer may have an average thickness greater than or equal to about 5 millimeters to less than or equal to about 10 millimeters, and at least one of the first and second dry powder layers may have an average thickness greater than or equal to about 5 millimeters to less than or equal to about 10 millimeters.

In at least one example embodiment, the contacting of the dry powder and the scenting material may include blending together the dry powder and the scenting material.

In at least one example embodiment, the contacting of the dry powder and the scenting material may include disposing at least one of the dry powder and the scenting material in a permeable bag.

In at least one example embodiment, the contacting of the dry powder and the scenting material may include adjusting temperature, pressure, humidity, or any combination thereof of the dry powder, the scenting material, or a combination of the dry powder and the scenting material.

In at least one example embodiment, the method may further include separating the scenting material and the dry powder.

In at least one example embodiment, the method may further include drying the dry powder, the dry powder having a moisture content of less than or equal to about 15%.

In at least one example embodiment, the contacting of the dry powder and the scenting material may be a first contacting, the scenting material may be a first scenting material, the desired time period may be a first desired time period, and the method may further include second contacting the dry powder and a second scenting material for a second desired time period.

In at least one example embodiment, between the first contacting and the second contacting, the method may further include drying the dry powder to have a moisture content of less than or equal to about 30%.

### BRIEF DESCRIPTION OF THE DRAWINGS

The various features and advantages of the non-limiting example embodiments herein may become more apparent upon review of the detailed description in conjunction with the accompanying drawings. The accompanying drawings are merely provided for illustrative purposes and should not be interpreted to limit the scope of the claims. The accompanying drawings are not to be considered as drawn to scale unless explicitly noted. For purposes of clarity, various dimensions of the drawings may have been exaggerated.

FIG. 1 is a perspective view of an aerosol-forming substrate in consolidated form according to at least one example embodiment of the present disclosure.

FIG. 2 is a perspective view of another aerosol-forming substrate in consolidated form according to at least one example embodiment of the present disclosure.

FIG. 3 is a perspective view of an aerosol-forming substrate in rod form according to at least one example embodiment of the present disclosure.

FIG. 4 is a schematic view of an aerosol-forming substrate including a plurality of aerosol-forming compounds according to at least one example embodiment of the present disclosure.

FIG. 5 is a cross-sectional view of an example aerosol-forming compound for inclusion in an aerosol-forming substrate according to at least one example embodiment of the present disclosure.

FIG. 6 is a top right perspective view of a capsule that includes an aerosol-forming substrate according to at least one example embodiment of the present disclosure.

FIG. 7 is a sectional view of the capsule of FIG. 6 along line XI-XI according to at least one example embodiment of the present disclosure.

FIG. 8 is an exploded view of the capsule of FIG. 6 according to at least one example embodiment of the present disclosure.

FIG. 9 is a perspective view of an aerosol-generating device configured to receive a capsule and having a lid in a closed position according to at least one example embodiment of the present disclosure.

FIG. 10 is a partial perspective view of the aerosol-generating device of FIG. 9 with the lid in an open position according to at least one example embodiment of the present disclosure.

FIG. 11 is a flowchart illustrating an example method for modifying sensory attributes of an aerosol-forming substrate according to at least one example embodiment of the present disclosure.

FIG. 12 is a side-view of an example layered structure formed during an example method for modifying sensory attributes of an aerosol-forming substrate according to at least one example embodiment of the present disclosure.

FIG. 13 is a flowchart illustrating an example method for contacting a dry powder and a scenting material according to at least one example embodiment of the present disclosure.

FIG. 14 is a flowchart illustrating another example method for contacting a dry powder and a scenting material according to at least one example embodiment of the present disclosure.

FIG. 15 is a flowchart illustrated another example method for modifying sensory attributes of an aerosol-forming substrate according to at least one example embodiment of the present disclosure.

### DETAILED DESCRIPTION

Some detailed example embodiments are disclosed herein. However, specific structural and function details disclosed herein are merely representative for purposes of describing some example embodiments. Some example embodiments may, however, be embodied in many alternate forms and should not be construed as limited to only the example embodiments set forth herein.

Accordingly, while some example embodiments are capable of various modifications and alternative forms, some example embodiments thereof are shown by way of example in the drawings and will herein be described in detail. It should be understood, however, that there is no intent to limit example embodiments to the particular forms disclosed, but to the contrary, example embodiments are to cover all modifications, equivalents, and alternatives thereof. Like numbers refer to like elements throughout the description of the figures.

It should be understood that when an element or layer is referred to as being “on,” “connected to,” “coupled to,” or “covering” another element or layer, it may be directly on, connected to, coupled to, or covering the other element or layer or intervening elements or layers may be present. In contrast, when an element is referred to as being “directly on,” “directly connected to,” or “directly coupled to” another element or layer, there are no intervening elements or layers present. Like numbers refer to like elements throughout the specification. As used herein, the term “and/or” includes any and all combinations or sub-combinations of one or more of the associated listed items.

It should be understood that, although the terms, first, second, third, etc., may be used herein to describe various elements, regions, layers and/or sections, these elements, regions, layers, and/or sections should not be limited by these terms. These terms are only used to distinguish one element, region, layer, or section from another region, layer, or section. Thus, a first element, region, layer or section discussed below could be termed a second element, region, layer, or section without departing from the teachings of example embodiments.

Spatially relative terms (e.g., “beneath,” “below,” “lower,” “above,” “upper,” and the like) may be used herein for ease of description to describe one element or feature's relationship to another element(s) or feature(s) as illustrated in the figures. It should be understood that the spatially relative terms are intended to encompass different orientations of the device in use or operation in addition to the orientation depicted in the figures. For example, if the device in the figures is turned over, elements described as “below”, or “beneath” other elements or features would then be oriented “above” the other elements or features. Thus, the term “below” may encompass both an orientation of above and below. The device may be otherwise oriented (rotated 90 degrees or at other orientations) and the spatially relative descriptors used herein interpreted accordingly.

The terminology used herein is for the purposes of describing various example embodiments only and is not intended to be limiting of example embodiments. As used herein, the singular forms “a,” “an,” and “the” are intended to include the plural forms as well, unless the context clearly indicates otherwise. It will be further understood that the terms “includes,” “including,” “comprises,” and/or “comprising,” when used in this specification, specify the presence of stated features, integers, steps, operations, and/or elements, but do not preclude the presence or addition of one or more other features, integers, steps, operations, elements, and/or groups thereof.

When the words “about” and “substantially” are used in this specification in connection with a numerical value, it is intended that the associated numerical value includes a manufacturing or operational tolerance (e.g., ±10%) around the stated numerical value. Moreover, when the terms “generally” or “substantially” are used in connection with geometric shapes, it is intended that precision of the geometric shape is not required but that latitude for the shape is within the scope of the disclosure. Furthermore, regardless of whether numerical values or shapes are modified as “about,” “generally,” or “substantially,” it will be understood that these values and shapes should be construed as including a manufacturing or operational tolerance (e.g., ±10%) around the stated numerical values or shapes.

Unless otherwise defined, all terms (including technical and scientific terms) used herein have the same meaning as commonly understood by one of ordinary skill in the art to which example embodiments belong. It will be further understood that terms, including those defined in commonly used dictionaries, should be interpreted as having a meaning that is consistent with their meaning in the context of the relevant art and will not be interpreted in an idealized or overly formal sense unless expressly so defined herein.

As described herein, any devices, electronic devices, modules, units, and/or portions thereof according to any of the example embodiments, and/or portions thereof may include, may be included in, and/or may be implemented by one or more instances of processing circuitry such as hardware including logic circuits; hardware/software combination such as a processor executing software; or a combination thereof. For example, the processing circuitry more specifically may include, but is not limited to, a central processing unit (CPU), an arithmetic logic unit (ALU), a graphics processing unit (GPU), an application processor (AP), a digital signal processor (DSP), a microcomputer, a field programmable gate array (FPGA), and programmable logic unit, application-specific integrated circuit (ASIC), a neural network processing unit (NPU), an Electronic Control Unit (ECU), and the like. In some example embodiments, the processing circuitry may include a non-transitory computer readable storage device (e.g., a memory), for example a solid-state drive (SSD), storing a program of instructions, and a processor (e.g., CPU) configured to execute the program of instructions to implement the functionality and/or methods performed by some or all of any devices, electronic devices, modules, units, and/or portions thereof according to any of the example embodiments.

At least one example embodiment relates to an aerosol-forming substrate for use in an aerosol-generating device.

An aerosol-forming substrate includes a material or combination of materials that may yield an aerosol. An aerosol relates to the matter generated or output by the devices disclosed, claimed, and equivalents thereof, including, for example, heated tobacco or heated tobacco products aerosol-generating devices. The material may include a compound (e.g., nicotine, cannabinoid), where an aerosol including the compound is produced when the material is heated. The heating may be below the combustion temperature so as to produce the aerosol without involving a substantial pyrolysis of the aerosol-forming substrate or the substantial generation of combustion byproducts (if any). Thus, in at least one example embodiment, pyrolysis does not occur during the heating and resulting production of aerosol. In other instances, however, there may be some pyrolysis and combustion byproducts, but the extent of the pyrolysis and combustion byproducts may be considered relatively minor and/or merely incidental.

In at least one example embodiment, the aerosol-forming substrate may include a fibrous material. The fibrous material is configured to release a compound when heated. The compound may be a naturally occurring constituent of the fibrous material. In at least one example embodiment, the fibrous material may include a botanical material. For instance, the fibrous material may include tobacco and the compound released may be nicotine. The term “tobacco” includes any tobacco plant material including tobacco leaf, tobacco plug, reconstituted tobacco, compressed tobacco, shaped tobacco, powder tobacco, or any combination thereof from one or more species of tobacco plants, including, for example, Nicotiana rustica and Nicotiana tabacum.

In at least one example embodiment, the tobacco material may include material from any member of the genus Nicotiana. In at least one example embodiment, the tobacco material may include a blend of two or more different tobacco varieties. Examples of suitable types of tobacco materials that may be used include, but are not limited to, flue-cured tobacco, Burley tobacco, Dark tobacco, Maryland tobacco, Oriental tobacco, rare tobacco, specialty tobacco, blends thereof, and the like. The tobacco material may be provided in any suitable form, including, but not limited to, tobacco lamina, processed tobacco materials (such as volume expanded or puffed tobacco), processed tobacco stems (such as cut-rolled or cut-puffed stems), reconstituted tobacco materials, blends thereof, and the like. In at least one example embodiment, the tobacco material may be in the form of a substantially dry tobacco mass.

In at least one example embodiment, the aerosol-forming substrate may include a naturally occurring constituent of a medicinal plant that has a medically accepted therapeutic effect. In at least one example embodiment, the medicinal plant may be a Cannabis plant and the compound may be a cannabinoid. Cannabinoids may interact with receptors in the body to produce a wide range of effects. As a result, cannabinoids have been used for a variety of medicinal purposes (e.g., treatment of pain, nausea, epilepsy, psychiatric disorders). In at least one example embodiment, the fibrous material as included in (e.g., defining) the aerosol-forming substrate may include the leaf and/or flower material from one or more species of Cannabis plants including, for example, Cannabis sativa, Cannabis indica, and/or Cannabis ruderalis. In at least one example embodiment, the fibrous material may include a mixture that includes greater than or equal to about 60% to less than or equal to about 80% (e.g., about 70%) of Cannabis sativa and greater than or equal to about 20% to less than or equal to about 40% (e.g., about 30%) of Cannabis indica.

Cannabinoids include, for example, tetrahydrocannabinolic acid (THCA), tetrahydrocannabinol (THC), cannabidiolic acid (CBDA), cannabidiol (CBD), cannabinol (CBN), cannabicyclol (CBL), cannabichromene (CBC), and cannabigerol (CBG). Tetrahydrocannabinolic acid (THCA) may be a precursor of tetrahydrocannabinol (THC), while cannabidiolic acid (CBDA) may be precursor of cannabidiol (CBD). In certain instances, tetrahydrocannabinolic acid (THCA) may be converted to tetrahydrocannabinol (THC), for example, via heating. In certain instances, cannabidiolic acid (CBDA) may be converted to cannabidiol (CBD) via heating. In at least one example embodiment, heat from a heater may cause decarboxylation so as to convert the tetrahydrocannabinolic acid (THCA) to tetrahydrocannabinol (THC) and/or to convert the cannabidiolic acid (CBDA) to cannabidiol (CBD).

In at least one example embodiment, the aerosol-forming substrate may include both tetrahydrocannabinolic acid (THCA) and tetrahydrocannabinol (THC). In such instances, decarboxylation and resulting conversion upon the application of heat may cause a decrease in tetrahydrocannabinolic acid (THCA) and an increase in tetrahydrocannabinol (THC). For example, at least about 50% (e.g., at least about 87%) of the tetrahydrocannabinolic acid (THCA) may be converted to tetrahydrocannabinol (THC) upon the application of heat. In at least one example embodiment, the aerosol-forming substrate may include both cannabidiolic acid (CBDA) and cannabidiol (CBD). In such instances, the decarboxylation and resulting conversion may cause a decrease in cannabidiolic acid (CBDA) and an increase in cannabidiol (CBD). For example, at least about 50% (e.g., at least about 87%) of the cannabidiolic acid (CBDA) may be converted to cannabidiol (CBD) upon the application of heat.

In at least one example embodiment, the aerosol-forming substrate may have a resistance to draw (RTD) of greater than or equal to about 30 mmH₂O (e.g., greater than or equal to about 40 mmH₂O, greater than or equal to about 50 mmH₂O, greater than or equal to about 60 mmH₂O, greater than or equal to about 70 mmH₂O, greater than or equal to about 80 mmH₂O, greater than or equal to about 90 mmH₂O, greater than or equal to about 100 mmH₂O, greater than or equal to about 110 mmH₂O, or greater than or equal to about 120 mmH₂O).

In at least one example embodiment, the aerosol-forming substrate may have a resistance to draw (RTD) of less than or equal to about 130 mmH₂O (e.g., less than or equal to about 120 mmH₂O, less than or equal to about 110 mmH₂O, less than or equal to about 100 mmH₂O, less than or equal to about 90 mmH₂O, less than or equal to about 80 mmH₂O, less than or equal to about 70 mmH₂O, less than or equal to about 60 mmH₂O, less than or equal to about 50 mmH₂O, or less than or equal to about 40 mmH₂O).

In at least one example embodiment, the aerosol-forming substrate may have a resistance to draw (RTD) that ranges from about 30 mmH₂O to about 130 mmH₂O (e.g., from about 60 mmH₂O to about 80 mmH₂O, from about 65 mmH₂O to about 75 mmH₂O, from about 67 mmH₂O to about 73 mmH₂O, or from about 69 mmH₂O to about 71 mmH₂O).

In at least one example embodiment, the aerosol-forming substrate may have a bulk density of greater than or equal to about 0.2 g/cm³ (e.g., greater than or equal to about 0.25 g/cm³, greater than or equal to about 0.3 g/cm³, greater than or equal to about 0.35 g/cm³, greater than or equal to about 0.4 g/cm³, greater than or equal to about 0.45 g/cm³, greater than or equal to about 0.5 g/cm³, greater than or equal to about 0.55 g/cm³, greater than or equal to about 0.6 g/cm³, greater than or equal to about 0.65 g/cm³, greater than or equal to about 0.7 g/cm³, greater than or equal to about 0.75 g/cm³).

In at least one example embodiment, the aerosol-forming substrate may have a bulk density of less than or equal to about 0.8 g/cm³ (e.g., less than or equal to about 0.75 g/cm³, less than or equal to about 0.7 g/cm³, less than or equal to about 0.65 g/cm³, less than or equal to about 0.6 g/cm³, less than or equal to about 0.55 g/cm³, less than or equal to about 0.5 g/cm³, less than or equal to about 0.45 g/cm³, less than or equal to about 0.4 g/cm³, less than or equal to about 0.35 g/cm³, less than or equal to about 0.3 g/cm³, or less than or equal to about 0.25 g/cm³).

In at least one example embodiment, the aerosol-forming substrate may have a bulk density that ranges from about 0.2 g/cm³ to about 0.8 g/cm³ (e.g., from about 0.3 g/cm³ to about 0.5 g/cm³, from about 0.35 g/cm³ to about 0.45 g/cm³, or from about 0.37 g/cm³ to about 0.43 g/cm³).

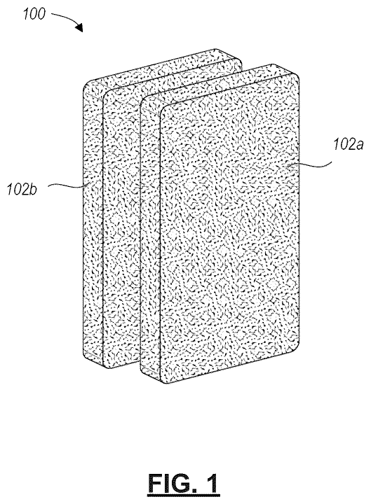

FIG. 1 is a perspective view of an aerosol-forming substrate 100 in consolidated form according to at least one example embodiment.

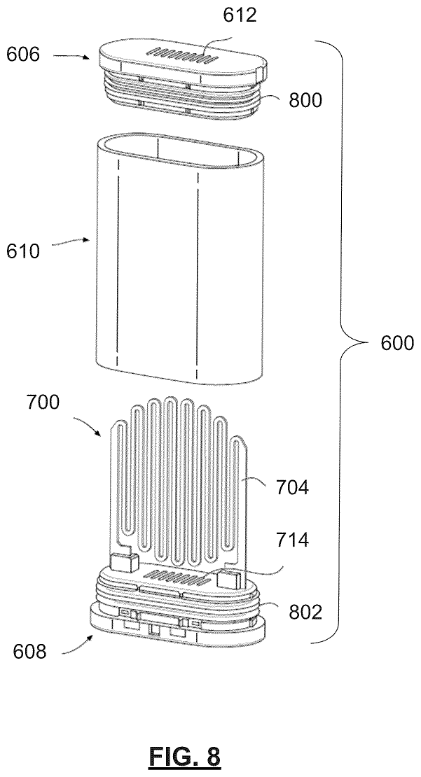

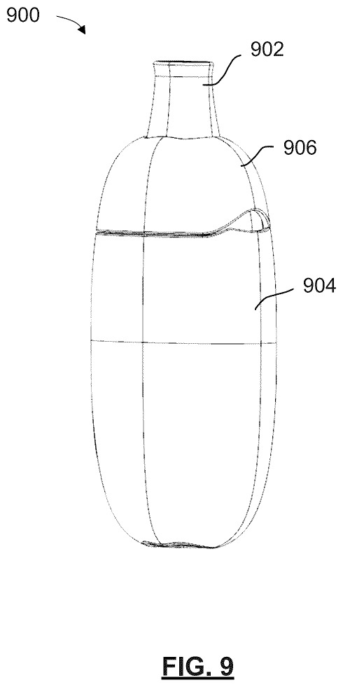

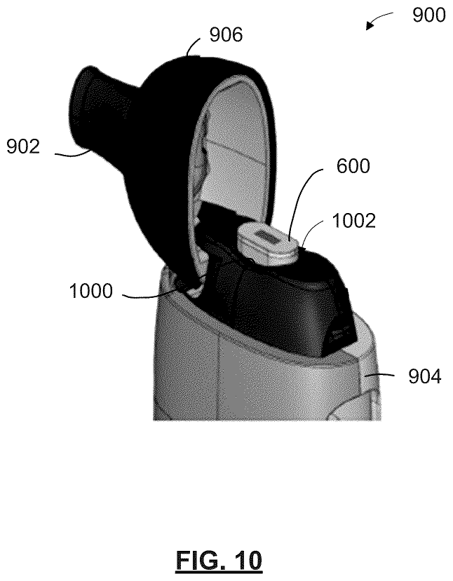

In at least one example embodiment, the aerosol-forming substrate 100 may include a first aerosol-forming substrate 102a and a second aerosol-forming substrate 102b to facilitate substrate loading during an assembly of a capsule that is configured, for example, for insertion into or use with an aerosol-generating device (e.g., capsule 600 in FIGS. 8-10 and aerosol-generating device 900 in FIGS. 9-10). Each of the first aerosol-forming substrate 102a and the second aerosol-forming substrate 102b may be in a consolidated form that is configured to maintain its shape so as to allow placement in a unified manner within a chamber of the capsule. For instance, the first aerosol-forming substrate 102a and the second aerosol-forming substrate 102b may be in the form of rectangular sheets/slabs dimensioned for insertion into the capsule.

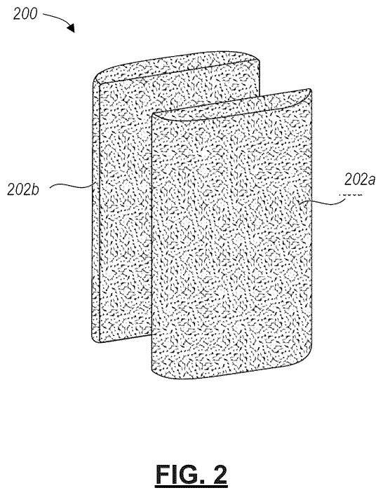

FIG. 2 is a perspective view of another aerosol-forming substrate 200 in consolidated form according to at least one example embodiment.

In at least one example embodiment, the aerosol-forming substrate 200 as illustrated in FIG. 2 may differ from the aerosol-forming substrate 100 as illustrated in FIG. 1 with regard only to its shape and dimensions. Otherwise, the aerosol-forming substrate 200 illustrated in FIG. 2 may be the same as described above in connection with the aerosol-forming substrate 100 as illustrated in FIG. 1.

The aerosol-forming substrate 200 may include a first aerosol-forming substrate 202a and a second aerosol-forming substrate 202b, where each may be in a consolidated form. For instance, the first aerosol-forming substrate 202a and the second aerosol-forming substrate 202b may be in the form of slabs or pallets with a semi-obround cross-section dimensioned for insertion into a capsule that is configured, for example, for insertion into or use with an aerosol-generating device. (e.g., capsule 600 in FIGS. 8-10 and aerosol-generating device 900 in FIGS. 9-10).

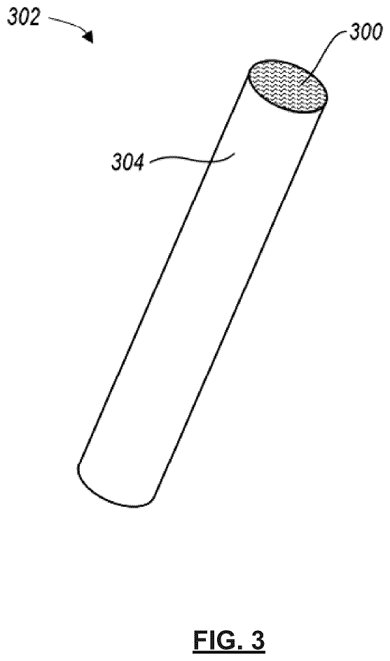

FIG. 3 is a perspective view of an aerosol-forming substrate 300 in rod form according to at least one example embodiment.

In at least one example embodiment, the aerosol-forming substrate 300 may be consolidated in the form of a rod 302. An exterior (e.g., circumference) of the aerosol-forming substrate 300 may be surrounded by a wrap 304. For instance, the wrap 304 may include a tipping paper or other suitable sheet material for wrapping. In at least one example embodiment, the rod 302 may be used in an aerosol-generating device without being in a capsule. It should be understood that the aerosol-forming substrate 300 may be in a consolidated form that retains its shape in the absence of the wrap 304 or, alternatively, in loose form so as to have a shape that is defined by the wrap 304.

Although not illustrated, it should be appreciated that, in at least one example embodiment, the aerosol-forming substrate may be in loose form (e.g., larger substrate that is ground into smaller pieces of the substrate). In such an instance, the aerosol-forming substrate may assume the shape of the space that contains it (e.g., chamber of a capsule). Additionally, for an aerosol-forming substrate in loose form, a vacuum-assisted filling process may be used to load the aerosol-forming substrate (e.g., into a capsule).

It should be appreciated that in each instance—i.e., the aerosol-forming substrate 100 as illustrated in FIG. 1 and/or the aerosol-forming substrate 200 as illustrated in FIG. 2 and/or the aerosol-forming substrate 300 as illustrated in FIG. 3 and/or the aerosol-forming substrate in loose form—the aerosol-forming substrate may include a plurality of aerosol-forming compounds dispersed within the aerosol-forming substrate.

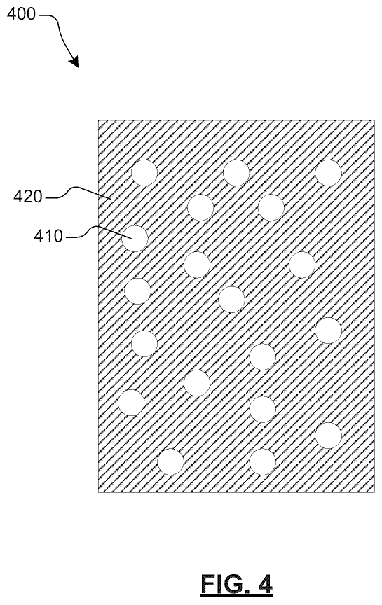

FIG. 4 is a schematic view of an aerosol-forming substrate 400 including a plurality of aerosol-forming compounds 410 according to at least one example embodiment.

In at least one example embodiment, the aerosol-forming substrate 400 may include a plurality of aerosol-forming compounds 410 dispersed within a matrix 420 defined by a fibrous material.

In at least one example embodiment, the aerosol-forming substrate 400 may include an amount of the plurality of aerosol-forming compounds 410 greater than or equal to about 0.01 wt. % (e.g., greater than or equal to about 1 wt. %, greater than or equal to about 5 wt. %, greater than or equal to about 10 wt. %, greater than or equal to about 15 wt. %, greater than or equal to about 20 wt. %, greater than or equal to about 25 wt. %, greater than or equal to about 30 wt. %, greater than or equal to about 35 wt. %, greater than or equal to about 40 wt. %, greater than or equal to about 45 wt. %, greater than or equal to about 50 wt. %, greater than or equal to about 55 wt. %, greater than or equal to about 60 wt. %, greater than or equal to about 65 wt. %, or greater than or equal to about 70 wt. %).

In at least one example embodiment, the aerosol-forming substrate 400 may include an amount of the plurality of aerosol-forming compounds 410 less than or equal to about 75 wt. % (e.g., less than or equal to about 70 wt. %, less than or equal to about 65 wt. %, less than or equal to about 60 wt. %, less than or equal to about 55 wt. %, less than or equal to about 50 wt. %, less than or equal to about 45 wt. %, less than or equal to about 40 wt. %, less than or equal to about 35 wt. %, less than or equal to about 30 wt. %, less than or equal to about 25 wt. %, less than or equal to about 20 wt. %, less than or equal to about 15 wt. %, less than or equal to about 10 wt. %, less than or equal to about 5 wt. %, or less than or equal to about 1 wt. %).

In at least one example embodiment, the aerosol-forming substrate 400 may include greater than or equal to about 0.01 wt. % to less than or equal to about 75 wt. % of the plurality of aerosol-forming compounds 410.

In at least one example embodiment, the matrix 420 may include tobacco material. The tobacco material may include tobacco lamina, a processed tobacco material, ground tobacco, processed tobacco stems, a reconstituted tobacco material, or any combination thereof.

In at least one example embodiment, the matrix 420 may include a tobacco substitute material. The tobacco substitute material may include wood pulp, cotton, sugar beets, bran, citrus pulp fiber, switch grass, salix tea, populus, bamboo, hemp, Cannabis, or any combination thereof.

The plurality of aerosol-forming compounds 410 may include an aerosol former, a solvent, an active ingredient, a pH-adjustor, a flavorant, a thermal conductivity modifier, or any combination thereof.

In at least one example embodiment, the aerosol former and solvent may be independently selected from water, propylene glycol, glycerol, ethanol, 2-propanol, butanediol, or any combination thereof.

In at least one example embodiment, the active ingredient may include nicotine, nicotine salt, nicotine solution, encapsulated nicotine, and any combination thereof.

In at least one example embodiment, the nicotine salt is formed between nicotine and citrate, monotartrate, bitartrate, bitartrate dihydrate, salicylate, sulfate, bisulfate, phosphate, acid phosphate, acetate, lactate, succinate, maleate, fumarate, gluconate, saccharate, benzoate, methanesulfonate, hydrochloride, hydrobromide, hydroiodide, caffeate, or any combination thereof.

In at least one example embodiment, the active ingredient may include 8-tetrahydrocannabinol (8-THC), tetrahydrocannabinol (THC), tetrahydrocannabinolic acid (THCA), tetrahydrocannabivarin (THCV), cannabidiol (CBD), cannabidiolic acid (CBDA), cannabinol (CBN), cannabichromene (CBC), cannabigerol (CBG), or any combination thereof.

In at least one example embodiment, the active ingredient may include nicotine, nicotine salt, nicotine solution, encapsulated nicotine, 8-tetrahydrocannabinol (8-THC), tetrahydrocannabinol (THC), tetrahydrocannabinolic acid (THCA), tetrahydrocannabivarin (THCV), cannabidiol (CBD), cannabidiolic acid (CBDA), cannabinol (CBN), cannabichromene (CBC), cannabigerol (CBG), or any combination thereof.

In at least one example embodiment, the pH-adjustor may include pyruvic acid, formic acid, oxalic acid, glycolic acid, acetic acid, isovaleric acid, valeric acid, propionic acid, octanoic acid, lactic acid, levulinic acid, sorbic acid, malic acid, tartaric acid, succinic acid, citric acid, benzoic acid, oleic acid, aconitic acid, butyric acid, cinnamic acid, decanoic acid, 3,7-dimethyl-6-octenoic acid, 1-glutamic acid, heptanoic acid, hexanoic acid, 3-hexenoic acid, trans-2-hexenoic acid, isobutyric acid, lauric acid, 2-methylbutyric acid, 2-methylvaleric acid, myristic acid, nonanoic acid, palmitic acid, 4-penenoic acid, phenylacetic acid, 3-phenylpropionic acid, hydrochloric acid, phosphoric acid, sulfuric acid, caffeic acid, ammonia, or any combination thereof.

In at least one example embodiment, the flavorant may include menthol, peppermint, spearmint, wintergreen, menthol, cinnamon, chocolate, vanillin, licorice, clove, anise, sandalwood, geranium, rose oil, vanilla, lemon oil, cassia, fennel, ginger, ethylacetate, isoamylacetate, propylisobutyrate, isobutylbutyrate, ethylbutyrate, ethylvalerate, benzylformate, limonene, cymene, pinene, linalool, geraniol, citronellol, citral, orange oil, coriander oil, borneol, fruit extract, coffee, tea, cacao, mint, pomegranate, acai, raspberry, blueberry, strawberry, boysenberry, cranberry, bourbon, scotch, whiskey, cognac, hydrangea, lavender, apple, peach, pear, cherry, plum, orange, lime, lichy, grape, grapefruit, butter, rum, coconut, almond, pecan, walnut, hazelnut, french vanilla, macadamia, sugar cane, maple, cassis, caramel, banana, malt, espresso, kahlua, white chocolate, cinnamon, clove, cilantro, basil, oregano, garlic, mustard, nutmeg, rosemary, thyme, tarragon, dill, sage, anise, fennel, methyl salicylate, linalool, jasmine, coffee, olive oil, sesame oil, sunflower oil, bergamot oil, geranium oil, lemon oil, ginger oil, balsamic vinegar, rice wine vinegar, red wine vinegar, allspice, pimento, mango, soursop, sweetsop, naseberry, sorrel, terpenes, or any combination thereof.

In at least one example embodiment, terpenes include 8-myrcene, 8-caryophyllene, d-limonene, linalool, pulegone, 1,8-conele, α-pipene, α-perpineol, termineol-4-ol, p-cymene, or any combination thereof.

In at least one example embodiment, the thermal conductivity modifier may include metal particles, metal granules, sheet metal (e.g., pieces, slivers), water, ceramic particles, graphene flakes, or any combination thereof.

It should be appreciated that, in at least one example embodiment, the first aerosol-forming substrate 102a and/or a second aerosol-forming substrate 102b of the aerosol-forming substrate 100 as illustrated in FIG. 1 may include a plurality of aerosol-forming compounds, like the plurality of aerosol-forming compounds 410 as illustrated in FIG. 4. It should be appreciated that, in at least one example embodiment, the first aerosol-forming substrate 202a and/or a second aerosol-forming substrate 202b of the aerosol-forming substrate 200 as illustrated in FIG. 2 may include a plurality of aerosol-forming compounds, like the plurality of aerosol-forming compounds 410 as illustrated in FIG. 4. It should be appreciated that, in at least one example embodiment, the rod 302 as illustrated in FIG. 3 may include a plurality of aerosol-forming compounds, like the plurality of aerosol-forming compounds 410 as illustrated in FIG. 4.

It should be appreciated that, in at least one example embodiment, the matrix 420 as illustrated in FIG. 4 may be prepared in a manner similar to the first aerosol-forming substrate 102a and/or a second aerosol-forming substrate 102b of the aerosol-forming substrate 100 as illustrated in FIG. 1. That is, in at least one example embodiment, the matrix 420 as illustrated in FIG. 4 may include a first substrate or portion or section or half and a second substrate or portion or section or half. Further, it should be appreciated that, in at least one example embodiment, the matrix 420 as illustrated in FIG. 4 may be prepared in a manner similar to the first aerosol-forming substrate 202a and/or a second aerosol-forming substrate 202b of the aerosol-forming substrate 200 as illustrated in FIG. 2. That is, in at least one example embodiment, the matrix 420 as illustrated in FIG. 4 may include a first substrate or portion or section or half and a second substrate or portion or section or half. Further still, it should be appreciated that, in at least one example embodiment, the matrix 420 as illustrated in FIG. 4 may be prepared in a manner similar to the rod 302 as illustrated in FIG. 3. That is, in at least one example embodiment, the matrix 420 as illustrated in FIG. 4 may be formed as a rod.

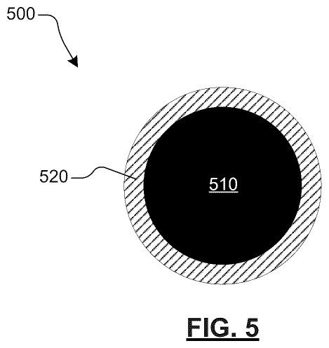

FIG. 5 is a cross-sectional view of an example aerosol-forming compound 500 for inclusion in an aerosol-forming substrate (like the aerosol-forming substrate of FIG. 1 and/or the aerosol-forming substrate of FIG. 2 and/or the aerosol-forming substrate of FIG. 3 and/or the aerosol-forming substrate of FIG. 4) according to at least one example embodiment.

In at least one example embodiment, the aerosol-forming compound 500 (or composite particle) may include a core 510 that includes the aerosol former, the solvent, the active ingredient, the pH-adjustor, the flavorant, the thermal conductivity modifier, or any combination thereof and that is substantially surrounded by an encapsulated material 520. Although, the encapsulating material 520 (which may also be referred to as an encapsulating layer or coating) is illustrated in FIG. 5 as a continuous layer, it should be appreciated that, in at least one example embodiment, the encapsulating material may cover greater than or equal to about 50% (e.g., greater than or equal to about 55%, greater than or equal to about 60%, greater than or equal to about 65%, greater than or equal to about 70%, greater than or equal to about 75%, greater than or equal to about 80%, greater than or equal to about 85%, greater than or equal to about 90%, greater than or equal to about 95%, greater than or equal to about 96%, greater than or equal to about 97%, greater than or equal to about 98%, or greater than or equal to about 99%) of a total surface area of the core 510. Similarly, although the core 510 is illustrated as a single particle, it should be appreciated that, in at least one example embodiment, the core 510 may include a collection or accumulation or agglomeration of particles.

In at least one example embodiment, the encapsulating layer 520 may include one or more first encapsulating materials having a first aerosolization temperature and one or more second encapsulating materials having a second aerosolization temperature that is different from the first aerosolization temperature. The first encapsulating material may form the encapsulating layer 520 over a core 510 that has a first aerosolization temperature. The second encapsulating material may form the encapsulating layer 520 over a core 510 that has a second aerosolization temperature.

In at least one example embodiment, the encapsulating layer 520 may include pectin, gelatin, sodium alginate, maltodextrin, pullulan, xanthan, gum acacia, hydroxypropylmethyl cellulose, sodium carboxy methyl cellulose, methyl cellulose, ethyl cellulose, hydroxypropyl cellulose, hydroxyethyl cellulose, polyethylene oxide, polyvinyl alcohol, polyvinyl pyrrolidone, polyethylene glycol, polyvinyl caprolactam, polyvinyl acetate, starch, starch-derivatives, or any combination thereof.

In at least one example embodiment, an aerosol-forming substrate may be included in a capsule that is configured, for example, for insertion or use with an aerosol-generating device. The aerosol-forming substrate may include or be similar to the aerosol-forming substrate 100 as illustrated in FIG. 1 and/or the aerosol-forming substrate 200 as illustrated in FIG. 2 and/or the aerosol-forming substrate 300 as illustrated in FIG. 3 and/or the aerosol-forming substrate 400 as illustrated in FIG. 4.

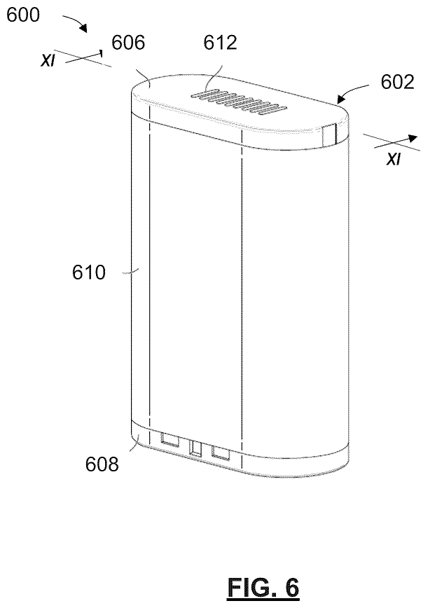

FIG. 6 is a top right perspective view of a capsule 600 that includes an aerosol-forming substrate (like the aerosol-forming substrate of FIG. 1 and/or the aerosol-forming substrate of FIG. 2 and/or the aerosol-forming substrate of FIG. 3 and/or the aerosol-forming substrate of FIG. 4) according to at least one example embodiment.

In at least one example embodiment, the capsule 600 has a housing 602 configured to contain an aerosol-forming substrate (e.g., aerosol-forming substrate 200 in FIG. 2 and/or aerosol-forming substrate 300 in FIG. 3 and/or the aerosol-forming substrate 400 as illustrated in FIG. 4). A downstream portion of the housing 602 may be in the form of a first end cap 606 (e.g., downstream cap). An upstream portion of the housing 602 may be in the form of a second end cap 608 (e.g., upstream cap, connector cap). The body portion of the housing may be in the form of a cover 610 (e.g., shell, box sleeve). The first end cap 606 may define a first opening 612. In at least one example embodiment, the first opening 612 may include a series of outlet openings (e.g., nine outlet openings).

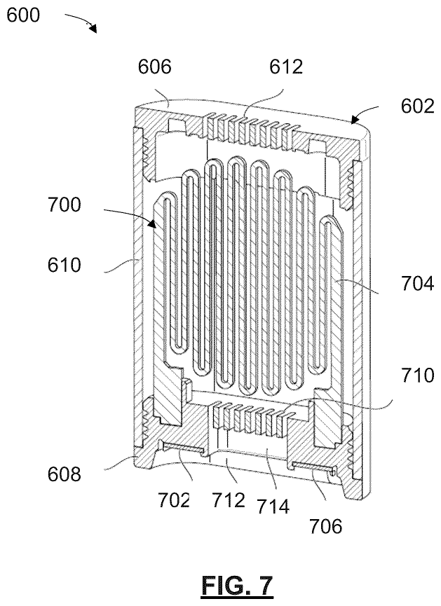

FIG. 7 is a sectional view of the capsule 600 along line XI-XI according to at least one example embodiment.

In at least one example embodiment, the housing 602 at least partially encloses and/or contains a heater 700. The heater 700 may include a conductive component having a first end section 702, an intermediate section 704, and a second end section 706. The intermediate section 704 may include an internal segment configured to heat the aerosol-forming substrate within the capsule 600. The first end section 702 and the second end section 706 may be external segments configured to establish an electrical connection with a power source.

In at least one example embodiment, the intermediate section 704 of the heater 700 may have a planar and winding form resembling a compressed oscillation or zigzag with a plurality of parallel segments (e.g., eight to sixteen parallel segments). However, it should be understood that other forms for the intermediate section 704 of the heater 700 are also possible (e.g., spiral form, flower-like form). The terminus of each of the first end section 702 and the second end section 706 may be oriented orthogonally to the plane of the intermediate section 704. Each of the first end section 702 and the second end section 706 may also include segments having a sideways J-shape. As a result, the first end section 702 and the second end section 706 may be embedded relatively securely within the second end cap 608 while providing a pair of electrical contact surfaces.

The second end cap 608 may define a second opening 710. In at least one example embodiment, the second opening 710 may be in the form of a series of inlet openings (e.g., eight inlet openings). In at least one example embodiment, the second end cap 608 may expose the first end section 702 and the second end section 706 of the heater 700. For example, as illustrated, the second opening 710 may be between the exposed portions of the first end section 702 and the second end section 706. In at least one example embodiment, the first end cap 606 and/or the second end cap 608 may be transparent so as to serve as windows configured to permit a viewing of the contents/components (e.g., aerosol-forming substrate and/or heater) within the capsule 600.

In addition to the second opening 710, the second end cap 608 may also define an alignment recess 712 and an inlet recess 714. The alignment recess 712 and the inlet recess 714 may be viewed as being in a multi-level arrangement, where the base/inner end surface of the alignment recess 712 (which exposes the first end section 702 and the second end section 706) may be regarded as being on one level and the base/inner end surface of the inlet recess 714 (or the grille-like surface of the second opening 710) may be regarded as being on another level. The alignment recess 712 may be configured to facilitate a positioning of the capsule 600 during its insertion into a device body of an aerosol-generating device (e.g., aerosol-generating device 900 of FIGS. 9-10). In at least one example embodiment, the alignment recess 712 may have angled sidewalls that taper inward toward the inlet recess 714. With the angled sidewalls, the alignment recess 712 may be quickly coupled with a corresponding engagement member of the device body with greater ease.

FIG. 8 is an exploded view of the capsule 600 according to at least one example embodiment.

In at least one example embodiment, the first end cap 606 may include a first sealing ridge 800 and the second end cap 608 may include a second sealing ridge 802. The first sealing ridge 800 may be in the form of a series of ribs (e.g., four ribs), and the second sealing ridge 802 may be in the form of a series of ribs (e.g., four ribs). In at least one example embodiment, the ribs in each of the series may be of different heights to ensure a desired contact with the cover 610. When the capsule 600 is assembled, the first sealing ridge 800 of the first end cap 606 and the second sealing ridge 802 of the second end cap 608 may be configured to interface with the inner surface of the cover 610 (e.g., via an interference fit) to provide an air seal. As a result, when air is directed to the capsule 600 during an operation of the aerosol-generating device (e.g., aerosol-generating device 900 of FIGS. 9-10), the air may enter the capsule 600 via the inlet recess 714 and the second opening 710 in the second end cap 608 (as opposed to entering the capsule 600 via a gap between the second end cap 608 and the cover 610, where such air may essentially just flow along the inner surface of the cover 610 so as to primarily bypass the aerosol-forming substrate and/or the intermediate section 704 of the heater 700). Similarly, with an appropriate seal, the aerosol generated within the chamber of the capsule 600 may be drawn out through the first opening 612 in the first end cap 606 (as opposed to leaking out through a gap between the first end cap 606 and the cover 610).

FIG. 9 is a perspective view of an aerosol-generating device 900 configured to receive a capsule (like the capsule 600 illustrated in FIGS. 6-9) and having a lid 906 in a closed position according to at least one example embodiment.

In at least one example embodiment, an aerosol-generating device 900 (e.g., heated tobacco or heated tobacco product aerosol-generating device) has a general oblong or pebble shape and a replaceable mouthpiece 902 that extends from the main body of the aerosol-generating device 900. For example, the aerosol-generating device 900 may include a housing 904 that receives a capsule, such as the capsule 600 as illustrated in FIGS. 6-9). The aerosol-generating device 900 may further include a lid 906 that is configured to open and close relative to the housing 904. The lid 906 may be configured to be coupled to the replaceable mouthpiece 902.

In at least one example embodiment, an exterior of the housing 904 and/or lid 906 may be formed from a metal (such as aluminum, stainless steel, and/or the like); an aesthetic, food contact rated plastic (such as a polycarbonate (PC), acrylonitrile butadiene styrene (ABS) material, liquid crystalline polymer (LCP), a copolyester plastic, and/or any other suitable polymer and/or plastic); or any combination thereof. The replaceable mouthpiece 902 may be similarly formed from a metal (such as aluminum, stainless steel, and/or the like); an aesthetic, food contact rated plastic (such as a polycarbonate (PC), acrylonitrile butadiene styrene (ABS) material, liquid crystalline polymer (LCP), a copolyester plastic, and/or any other suitable polymer and/or plastic); and/or plant-based materials (such as wood, bamboo, and/or the like). One or more interior surfaces or the housing 904 and/or lid 906 may be formed from or coated with a high temperature plastic (such as polyetheretherketone (PEEK), liquid crystal polymer (LCP), and/or the like). The lid 906 and the housing 904 may be collectively regarded as the main body of the aerosol-generating device 900.

In at least one example embodiment, the housing 904 encases or houses a latch release mechanism for the lid 906, a power source, and a processing or control circuity. The control circuity may be hardware including logic circuits; a hardware/software combination (such as a processor executing software); or any combination thereof. For example, the control circuitry may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), and/or the like. The supply of current from the power source may be in response to a manual operation (e.g., button activation) or an automatic operation (e.g., puff-activation). The power source may include one or more batteries (e.g., rechargeable dual battery arrangement, lithium-ion battery, and/or fuel cells). In at least some example embodiments, the control circuity may further include a haptic motor that may be disposed on a side of the power source.

FIG. 10 is a partial perspective view of the aerosol-generating device 900 with the lid 906 in an open position according to at least one example embodiment.

In at least one example embodiment, the housing 904 is configured to enclose a capsule connector 1000. In at least one example embodiment, the capsule connector 1000 may be mounted or otherwise secured to a printed circuit board (PCB) within the housing 1004. In at least one example embodiment, the capsule connector 1000 defines the capsule-receiving cavity 1002.

In at least one example embodiment, the method of control/heating and associated circuitry and electrical contacts (e.g., capsule connector 1000 having electrical contacts) may be as described in U.S. application Ser. No. 17/151,375 filed Jan. 18, 2021 and titled “Heat-Not-Burn (HNB) Aerosol-Generating Devices Including Energy Based Heater Control, And Methods Of Controlling A Heater,” which published as U.S. Pub. No. 2022/0225685, and/or U.S. application Ser. No. 17/151,409 filed Jan. 18, 2021 and titled “Heat-Not-Burn (HNB) Aerosol-Generating Devices Including Intra-Draw Heater Control, and Methods of Controlling a Heater,” which published as U.S. Pub. No. 2022/0229453, the entire contents of each of which are incorporated herein by reference.

In at least one example embodiment, the capsule 600 may be loaded into the aerosol-generating device 900 by initially inserting the capsule 600 into the capsule-receiving cavity 1002 defined by the capsule connector 1000. In at least one example embodiment, the capsule 600 may make contact (e.g., full contact) with electrical contacts within capsule-receiving cavity 1002 only upon the application of force (e.g., downward/inward force) to the capsule 600. In at least one example embodiment, a force may be applied to the capsule 600 by the closure and/or latching of the lid 906. In other example embodiments, a force may be applied to the capsule 600 by an adult consumer. In still other example embodiments, a force may be applied by a combination of pressure applied by the adult consumer and the closure and/or latching of the lid 906. In each instance, a forced may be applied until a resistance is felt and/or a clicking sound is heard, which signals a complete engagement of the capsule 600 in the capsule-receiving cavity 1002.

Additional details and/or alternatives for the aerosol-generating device 900, the capsule 600, and/or the aerosol-forming substrate (e.g., aerosol-forming substrate 200 in FIG. 2 and/or aerosol-forming substrate 300 in FIG. 3 and/or the aerosol-forming substrate 400 as illustrated in FIG. 4) may be found in U.S. application Ser. No. 17/151,277 filed Jan. 18, 2021 and titled “Capsules Including Embedded Heaters And Heat-Not-Burn (HNB) Aerosol-Generating Devices,” which published as U.S. Pub. No. 2022/0225667, and/or U.S. application Ser. No. 17/151,327 filed Jan. 18, 2021 and titled “Heat-Not-Burn (HNB) Aerosol-Generating Devices And Capsules,” which published as U.S. Pub. No. 2022/0225672, and/or U.S. application Ser. No. 17/151,336 filed Jan. 18, 2021 and titled “Heat-Not-Burn (HNB) Aerosol-Generating Devices And Capsules”, which published as U.S. Pub. No. 2022/0225669, and/or U.S. application Ser. No. 17/151,340 filed Jan. 18, 2021 and titled “Heat-Not-Burn (HNB) Aerosol-Generating Devices And Capsules,” which published as U.S. Pub. No. 2022/0225670, and/or U.S. application Ser. No. 17/947,436 filed Sep. 19, 2022 and titled “Heat-Not-Burn (HNB) Aerosol-Generating Devices And Capsules,” which published as U.S. Pub. No. 2024/0090574, and/or U.S. application Ser. No. 17/981,973 filed Nov. 7, 2022 and titled “Capsules Having Electrical Contact Pads With Surface Discontinuities And Heat-Not-Burn (HNB) Aerosol-Generating Devices Including The Same,” which published as U.S. Pub. No. 2024/0091467, and/or U.S. application Ser. No. 29/859,073 filed Nov. 7, 2023 and titled “Aerosol-Generating Capsules,” which issued as D875,938, and/or U.S. application Ser. 29/859076 filed Nov. 7, 2022 and titled “Electrical Contact Pads,” and/or U.S. application Ser. No. 29/853,736 filed Sep. 19, 2022 and titled “Heat-Not-Burn Aerosol Generating Device With A Flip-Top Lid,” and/or U.S. application Ser. No. 17/982,138 filed Nov. 7, 2022 and titled “Heat-Not-Burn (Hnb) Aerosol-Generating Devices And Capsules Having Electrical Contact Pads With Surface Discontinuities,” the entire contents of each of which are incorporated herein by reference.

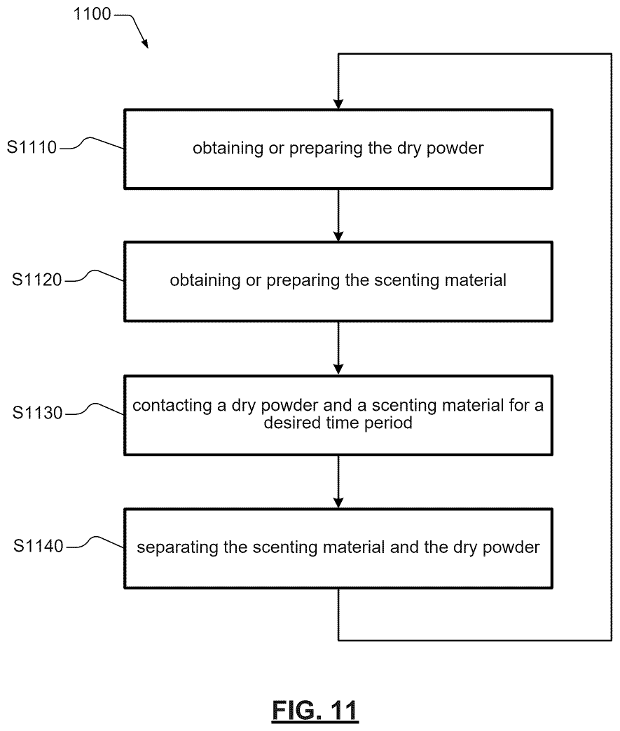

FIG. 11 is a flowchart illustrating an example method 1100 for modifying sensory attributes of an aerosol-forming substrate (e.g., aerosol-forming substrate 200 in FIG. 2 and/or aerosol-forming substrate 300 in FIG. 3 and/or aerosol-forming substrate 400 as illustrated in FIG. 4) that may be incorporated into a capsule (e.g., capsule 600 illustrated in FIG. 6) and/or received by an aerosol-generating device (e.g., like the aerosol-generating device 900 illustrated in FIG. 9) that may be configured to receive a capsule.

The method 1100 may include, for example, obtaining and/or preparing S1110 a dry powder, obtaining and/or preparing S1120 a scenting material, contacting S1130 the dry powder and the scenting material for a desired time period, and optionally separating S1140 the scenting material and the dry powder.

The dry powder may include a material or combination of materials that may yield an aerosol. The dry powder may include, for example, a fibrous material. In at least one example embodiment, the fibrous material may include, for example, tobacco, Cannabis, or a combination of tobacco and Cannabis.

In at least one example embodiment, the dry powder may have a moisture content less than or equal to about 12% (e.g., less than or equal to about 11%, less than or equal to about 10%, less than or equal to about 9%, less than or equal to about 8%, or less than or equal to about 7%)

In at least one example embodiment, the dry powder may have a moisture content greater than or equal to about 6% (e.g., greater than or equal to about 7%, greater than or equal to about 8%, greater than or equal to about 9%, greater than or equal to about 10%, or greater than or equal to about 11%).

In at least one example embodiment, the dry powder may have a moisture content greater than or equal to about 6% to less than or equal to about 12%.

In at least one example embodiment, the method 1100 may include obtaining or preparing S1110 the dry powder before, or simultaneously with, the contacting S1130 of the dry powder and the scenting material. In at least one example embodiment, the dry powder may be prepared S1110 by drying the dry powder to achieve a desired or selected moisture, such as noted above.

The scenting material may include a natural scent source. The natural scent source may include, for example, fresh materials, cured or dried materials, or a combination of fresh materials and cured or dried materials. In at least one example embodiment, the natural scent source may include mint, citrus, ginger root, cinnamon granules, vanilla beans, dried mint, clove, anise, or any combination thereof. In at least one example embodiment, the natural scent source may include a fresh material and the fresh material may include fresh mint, fresh citrus, fresh ginger root, or any combination thereof. In at least one example embodiment, the citrus may include lemon. In at least one example embodiment, the cured or dried materials may include cinnamon granules, vanilla beans, dried mint, clove, anise, or any combination thereof.

A (first) moisture content of a scenting material including a fresh material may be greater than a (second) moisture content of a scenting material including a cured or dried material.

In at least one example embodiment, the scenting material may include a fresh material and may have a moisture content greater than or equal to about 60% (e.g., greater than or equal to about 61%, greater than or equal to about 62%, greater than or equal to about 63%, greater than or equal to about 64%, greater than or equal to about 65%, greater than or equal to about 66%, greater than or equal to about 67%, greater than or equal to about 68%, greater than or equal to about 69%, greater than or equal to about 70%, greater than or equal to about 71%, greater than or equal to about 72%, greater than or equal to about 73%, greater than or equal to about 74%, greater than or equal to about 75%, greater than or equal to about 76%, greater than or equal to about 77%, greater than or equal to about 78%, or greater than or equal to about 79%).

In at least one example embodiment, the scenting material may include a fresh material and may have a moisture content less than or equal to about 80% (e.g., less than or equal to about 79%, less than or equal to about 78%, less than or equal to about 77%, less than or equal to about 76%, less than or equal to about 75%, less than or equal to about 74%, less than or equal to about 73%, less than or equal to about 72%, less than or equal to about 71%, less than or equal to about 70%, less than or equal to about 69%, less than or equal to about 68%, less than or equal to about 67%, less than or equal to about 66%, less than or equal to about 65%, less than or equal to about 64%, less than or equal to about 63%, less than or equal to about 62%, or less than or equal to about 61%).

In at least one example embodiment, the scenting material may include a fresh material and may have a moisture content greater than or equal to about 60% to less than or equal to about 80%.

In at least one example embodiment, the scenting material may include a cured or dried material and may have a moisture content of greater than or equal to about 5% (e.g., greater than or equal to about 6%, greater than or equal to about 7%, greater than or equal to about 8%, greater than or equal to about 9%, greater than or equal to about 10%, greater than or equal to about 11%, greater than or equal to about 12%, greater than or equal to about 13%, greater than or equal to about 14%, greater than or equal to about 15%, greater than or equal to about 16%, or greater than or equal to about 17%).

In at least one example embodiment, the scenting material may include a cured or dried material and may have a moisture content of less than or equal to about 18% (e.g., less than or equal to about 17%, less than or equal to about 16%, less than or equal to about 15%, less than or equal to about 14%, less than or equal to about 13%, less than or equal to about 12%, less than or equal to about 11%, less than or equal to about 10%, less than or equal to about 9%, less than or equal to about 8%, less than or equal to about 7%, or less than or equal to about 6%).

In at least one example embodiment, the scenting material may include a cured or dried material and may have a moisture content of greater than or equal to about 5% to less than or equal to about 18% (e.g., greater than or equal to about 10% to less than or equal to about 15%).

In at least one example embodiment, the method 1100 may include obtaining or preparing S1120 the scenting material before, or simultaneously with, the contacting S1130 of the dry powder and the scenting material. In at least one example embodiment, preparing S1120 the scenting material may include curing or drying the scenting material. In at least one example embodiment, preparing S1120 the scenting material may include selecting an appropriate or desired size and/or modifying the size of fresh scenting materials.

Although the obtaining or preparing S1120 of the scenting material is illustrated as following the obtaining or preparing S1110 of the dry powder it should be appreciated that, in various example embodiments, these steps may occur simultaneously, or further, in other example embodiments, the obtaining or preparing S1110 of the dry powder may follow the obtaining or preparing S1120 of the scenting material, or further still, in other example embodiments, the obtaining or preparing S1110 of the dry powder and/or the obtaining or preparing S1120 of the scenting material may occur simultaneously with the contacting S1130 of the dry powder and the scenting material.

The desired time period for the contacting S1130 of the dry powder and the scenting material may be different in response to the nature of, or the selected, scenting material and/or the dry powder.

In at least one example embodiment, the scenting material may include a fresh material and the desired time period for the contacting S1130 of the dry powder and the scenting material may be greater than or equal to about 24 hours (e.g., greater than or equal to about 25 hours, greater than or equal to about 30 hours, greater than or equal to about 35 hours, greater than or equal to about 40 hours, greater than or equal to about 45 hours, greater than or equal to about 50 hours, greater than or equal to about 55 hours, greater than or equal to about 60 hours, greater than or equal to about 65 hours, greater than or equal to about 70 hours, greater than or equal to about 75 hours, greater than or equal to about 80 hours, greater than or equal to about 85 hours, greater than or equal to about 90 hours, greater than or equal to about 95 hours, greater than or equal to about 100 hours, greater than or equal to about 105 hours, greater than or equal to about 110 hours, or greater than or equal to about 115 hours).

In at least one example embodiment, the scenting material may include a fresh material and the desired time period for the contacting S1130 of the dry powder and the scenting material may be less than or equal to about 120 hours (e.g., less than or equal to about 115 hours, less than or equal to about 110 hours, less than or equal to about 105 hours, less than or equal to about 100 hours, less than or equal to about 95 hours, less than or equal to about 90 hours, less than or equal to about 85 hours, less than or equal to about 80 hours, less than or equal to about 75 hours, less than or equal to about 70 hours, less than or equal to about 65 hours, less than or equal to about 60 hours, less than or equal to about 55 hours, less than or equal to about 50 hours, less than or equal to about 45 hours, less than or equal to about 40 hours, less than or equal to about 35 hours, less than or equal to about 30 hours, or less than or equal to about 25 hours).

In at least one example embodiment, the scenting material may include a fresh material and the desired time period for the contacting S1130 of the dry powder and the scenting material may be greater than or equal to about 24 hours to less than or equal to about 120 hours (e.g., greater than or equal to about 24 hours to less than or equal to about 48 hours).

In at least one example embodiment, the scenting material may include a fresh material and the desired time period for the contacting S1130 of the dry powder and the scenting material may be less than or equal to about 120 hours to avoid mold contamination.

In at least one example embodiment, the scenting material may include a cured or dried material and the desired time period for the contacting S1130 of the dry powder and the scenting material may be greater than or equal to about 72 hours (e.g., greater than or equal to about 75 hours, greater than or equal to about 80 hours, greater than or equal to about 85 hours, greater than or equal to about 90 hours, greater than or equal to about 95 hours, greater than or equal to about 100 hours, greater than or equal to about 105 hours, greater than or equal to about 110 hours, or greater than or equal to about 115 hours).

In at least one example embodiment, the scenting material may include a cured or dried material and the desired time period for the contacting S1130 of the dry powder and the scenting material may be less than or equal to about 120 hours (e.g., less than or equal to about 115 hours, less than or equal to about 110 hours, less than or equal to about 105 hours, less than or equal to about 100 hours, less than or equal to about 95 hours, less than or equal to about 90 hours, less than or equal to about 85 hours, less than or equal to about 80 hours, or less than or equal to about 75 hours).

In at least one example embodiment, the scenting material may include a cured or dried material and the desired time period for the contacting S1130 of the dry powder and the scenting material may be greater than or equal to about 72 hours to less than or equal to about 120 hours (e.g., greater than or equal to about 96 hours to less than or equal to about 120 hours).

The contacting S1130 of the dry powder and the scenting material may include adjusting temperature, pressure, humidity, or any combination thereof of the dry powder, the scenting material, or a combination of the dry powder and the scenting material. For example, in at least one example embodiment, the temperature of the contacting S1130 of the dry powder and the scenting material may be determined or selected in response to the nature of the selected scenting material for the contacting S1130 of the dry powder and the scenting material. In at least one example embodiment, high pressures may provide a higher density of air as a medium to facilitate mass transfer of flavor components. In at least one example embodiment, reduced humidities may provide a higher density of air as a medium to facilitate mass transfer of flavor components.

In at least one example embodiment, the scenting material may include a fresh material and the contacting S1130 of the dry powder and the scenting material may occur at room temperature (e.g., greater than or equal to about 20° C. to less than or equal to about 22° C.).

In at least one example embodiment, the scenting material may include a fresh material and the contacting S1130 of the dry powder and the scenting material may occur at room temperature greater than or equal to about 20° C. (e.g., greater than or equal to about 21° C., greater than or equal to about 22° C., greater than or equal to about 23° C., greater than or equal to about 24° C., greater than or equal to about 25° C., greater than or equal to about 26° C., greater than or equal to about 27° C., greater than or equal to about 28° C., or greater than or equal to about 29° C.).

In at least one example embodiment, the scenting material may include a fresh material and the contacting S1130 of the dry powder and the scenting material may occur at room temperature less than or equal to about 30° C. (e.g., less than or equal to about 29° C., less than or equal to about 28° C., less than or equal to about 27° C., less than or equal to about 26° C., less than or equal to about 25° C., less than or equal to about 24° C., less than or equal to about 23° C., less than or equal to about 22° C., or less than or equal to about 21° C.).

In at least one example embodiment, the scenting material may include a fresh material and the contacting S1130 of the dry powder and the scenting material may occur at room temperature greater than or equal to about 20° C. to less than or equal to about 30° C. (e.g., greater than or equal to about 20° C. to less than or equal to about 22° C.).

In at least one example embodiment, the scenting material may include a fresh material and the temperature of the contacting S1130 of the dry powder and the scenting material may be less than or equal to about 30° C. to avoid mold contamination.

In at least one example embodiment, the scenting material may include a cured or dried material and the contacting S1130 of the dry powder and the scenting material may occur at a temperature of greater than or equal to about 20° C. (e.g., greater than or equal to about 21° C., greater than or equal to about 22° C., greater than or equal to about 23° C., greater than or equal to about 24° C., greater than or equal to about 25° C. greater than or equal to about 26° C., greater than or equal to about 27° C., greater than or equal to about 28° C., greater than or equal to about 29° C., greater than or equal to about 30° C., greater than or equal to about 31° C., greater than or equal to about 32° C., greater than or equal to about 33° C., greater than or equal to about 34° C., greater than or equal to about 35° C., greater than or equal to about 36° C., greater than or equal to about 37° C., greater than or equal to about 38° C., or greater than or equal to about 39° C. ).

In at least one example embodiment, the scenting material may include a cured or dried material and the contacting S1130 of the dry powder and the scenting material may occur at a temperature of less than or equal to about 40° C. (e.g., less than or equal to about 39° C., less than or equal to about 38° C., less than or equal to about 37° C., less than or equal to about 36° C., less than or equal to about 35° C., less than or equal to about 34° C., less than or equal to about 33° C., less than or equal to about 32° C., less than or equal to about 31° C., less than or equal to about 30° C., less than or equal to about 29° C., less than or equal to about 28° C., less than or equal to about 27° C., or less than or equal to about 26° C.).

In at least one example embodiment, the scenting material may include a cured or dried material and the contacting S1130 of the dry powder and the scenting material may occur at a temperature of greater than or equal to about 20° C. to less than or equal to about 40° C. (e.g., about 25° C., about 30° C., about 37° C., or about 40° C.).

In at least one example embodiment, a mass ratio of the contacting S1130 of the dry powder and the scenting material may be greater than or equal to about 1:1 (e.g., greater than or equal to about 2:1). In at least one example embodiment, a mass ratio of the contacting S1130 of the dry powder and the scenting material may be less than or equal to about 1:2. In at least one example embodiment, a mass ratio of the contacting S1130 of the dry powder and the scenting material may be greater than or equal to about 2:1 to less than or equal to about 1:2. In at least one example embodiment, the contacting S1130 of the dry powder and the scenting material may include blending together the dry powder and the scenting material.

In at least one example, the contacting S1130 of the dry powder and the scenting material may include disposing at least one of the dry powder and the scenting material in a permeable bag. For example, scenting materials may be disposed in one or more permeable bags when brittle scenting materials are selected, such as dry mint or cinnamon granules. Bittle scenting materials may include materials that readily produce particles that cannot be easily separated from the dry powder using a mesh. In at least one example embodiment, the permeable bags may include miracloth. In at least one example embodiment, the permeable bags may have an average pore size less than or equal to about 100 micrometers (e.g., greater than or equal to about 22 micrometers to less than or equal to about 25 micrometers).

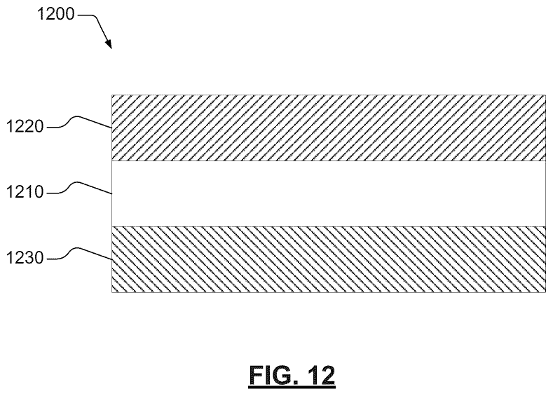

In at least one example embodiment, the contacting S1130 of the dry powder and the scenting material may include forming a layered structure, like the layered structure 1200 illustrated in FIG. 12. As illustrated, the layered structure 1200 may include a first layer 1210 disposed between first and second layers 1220, 1230. Although three layers are illustrated, it should be appreciated that, in various example embodiments, the layered structure 1200 may include two or more distinct layers.

In at least one example embodiment, the first layer 1210 may be a scenting layer disposed between first and second dry powder layers 1220, 1230, where the scenting material layer 1210 may include a scenting material and each of the first and second dry powder layers 1220, 1230 may include the same or different dry powders. In other example embodiment, the first layer 1210 may be a dry powder layer disposed between first and second scenting material layers 1220, 1230, where the dry powder layer 1210 may include a dry powder and each of the first and second dry powder layers 1220, 1230 may include the same or different scenting materials.

In at least one example embodiment, each of the first, second, and third layers 1210, 1220, 1230 may have an individual average thickness greater than or equal to about 5 millimeters (e.g., greater than or equal to about 6 millimeters, greater than or equal to about 7 millimeter, greater than or equal to about 8 millimeters, or greater than or equal to about 9 millimeters).

In at least one example embodiment, each of the first, second, and third layers 1210, 1220, 1230 may have an individual average thickness less than or equal to about 10 millimeters (e.g., less than or equal to about 9 millimeters, less than or equal to about 8 millimeters, less than or equal to about 7 millimeters, or less than or equal to about 6 millimeters).

In at least one example embodiment, each of the first, second, and third layers 1210, 1220, 1230 may have an individual average thickness greater than or equal to about 5 millimeters to less than or equal to about 10 millimeters.

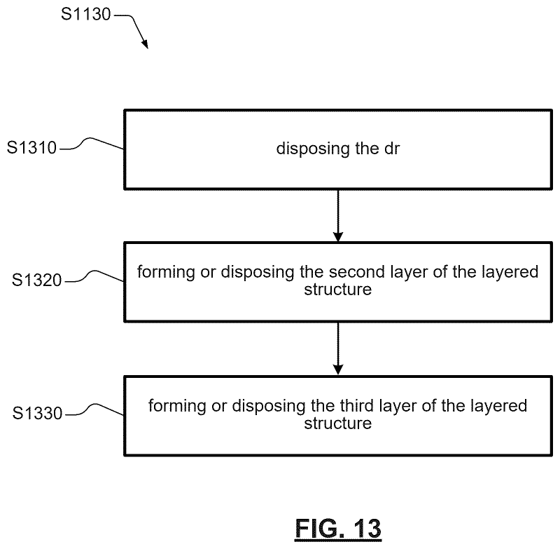

In at least one example embodiment, the contacting S1130 of the dry powder and the scenting material may include, as illustrated in FIG. 13, forming (or disposing) S1310 the first layer 1210, forming (or disposing) S1320 the second layer 1220, and forming (or disposing) S1330 the third layer 1230. Although illustrated as subsequential steps, it should be appreciated that, in various example embodiments, the forming (or disposing) S1310 of the first layer 1210 may occur simultaneously with the forming (or disposing) S1320 of the second layer 1220 and/or the forming (or disposing) 1330S of the third layer 1220, and/or further, in various example embodiments, the forming (or disposing) S1320 of the second layer 1220 may occur simultaneously with the forming (or disposing) S1310 of the first layer 1210 and/or the forming (or disposing) 1330S of the third layer, and/or further still, in various example embodiments, the forming (or disposing) S1330 of the third layer 1230 may occur simultaneously with the forming (or disposing) S1310 of the first layer and/or the forming (or disposing) 1320S of the second layer, and/or further still, in various example embodiments, the forming (or disposing) S1310 of the first layer 1210 may occur before the forming (or disposing) S1320 of the second layer 1220 and/or the forming (or disposing) 1330S of the third layer 1220, and/or further still, in various example embodiment, the forming (or disposing) S1320 of the second layer 1220 may occur before the forming (or disposing) S1310 of the first layer 1210 and/or the forming (or disposing) 1330S of the third layer, and/or further still, the forming (or disposing) S1330 of the third layer 1130 may occur before the forming (or disposing) S1310 of the first layer and/or the forming (or disposing) 1320S of the second layer.

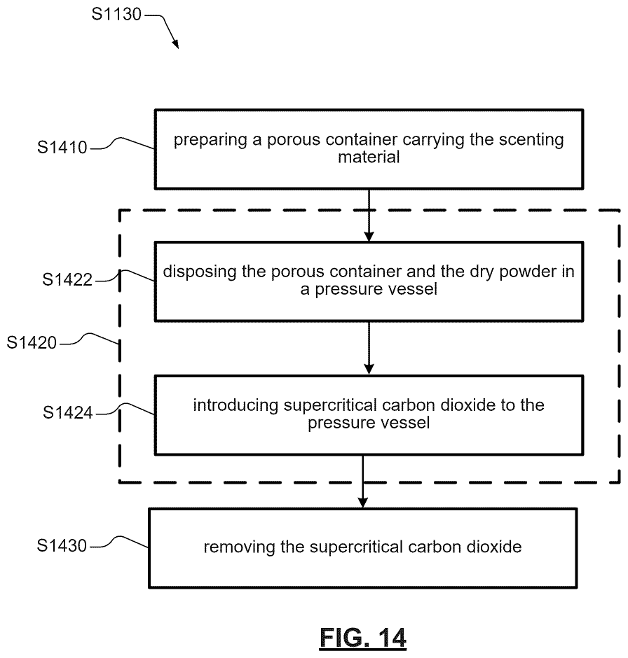

In at least one example embodiment, the contacting S1130 of the dry powder and the scenting material may include subjecting the dry powder and the scenting material to a supercritical carbon dioxide treatment. The supercritical carbon dioxide treatment may include, as illustrated in FIG. 14, contacting S1420 may include introducing the scenting material and the dry powder into an environment including supercritical carbon dioxide. The scenting material and the dry powder may be added to the environment including the supercritical carbon dioxide concurrently or subsequently. For example, in at least one example embodiment, at least a portion of the scenting material may be added to the environment including the supercritical carbon dioxide at the same time as at least a portion of the dry powder. In other example embodiment, one of the scenting material and the dry powder may be added to the environment including the supercritical carbon dioxide and subsequently the other of the scenting material and the dry powder may be added to the environment including the supercritical carbon dioxide.

In at least one example embodiment, the contacting S1420 may include introducing a porous container (e.g., a mesh container) that carries the scenting material. When the porous container including the scenting material is introduced, the contacting S1130 (and in turn, the method 1100) may include preparing the porous container. In at least one example embodiment, the contacting S1420 may include disposing S1422 the scenting material (with or without the porous container) and the dry powder in a pressure vessel and introducing S1424 supercritical carbon dioxide to the pressure vessel. The disposing S1422 and the introducing S1424 of the carbon dioxide in the supercritical state may occur concurrently or subsequently. For example, in at least one example embodiment, at least part of the disposing S1422 may occur at the same time as at least part of the introducing S1424. In other example embodiments, the scenting material (with or without the porous container) and the dry powder may occur before the introduction S1424 of the carbon dioxide in the supercritical state.

In at least one example embodiment, the introduction S1424 may include introducing carbon dioxide in the supercritical state. In other example embodiments, the introduction S1424 may include changing one or both of the pressure and temperature to move carbon dioxide to its supercritical state. In each instance, the supercritical carbon dioxide may have a temperature greater than or equal to about 31.1° C. to less than or equal to about 60° C. (e.g., greater than or equal to about 32° C. to less than or equal to about 58° C., greater than or equal to about 34° C. to less than or equal to about 56° C., greater than or equal to about 36° C. to less than or equal to about 54° C., greater than or equal to about 38° C. to less than or equal to about 52° C., greater than or equal to about 40° C. to less than or equal to about 50° C., greater than or equal to about 42° C. to less than or equal to about 48° C., or greater than or equal to about 44° C. to less than or equal to about 46° C.) and a pressure greater than or equal to about 73.8 bar to less than or equal to about 300 bar (e.g., greater than or equal to about 80 bar to less than or equal to about 290 bar, greater than or equal to about 90 bar to less than or equal to about 280 bar, greater than or equal to about 100 bar to less than or equal to about 270 bar, greater than or equal to about 110 bar to less than or equal to about 260 bar, greater than or equal to about 120 bar to less than or equal to about 250 bar, greater than or equal to about 130 bar to less than or equal to about 240 bar, greater than or equal to about 140 bar to less than or equal to about 230 bar, greater than or equal to about 150 bar to less than or equal to about 220 bar, greater than or equal to about 160 bar to less than or equal to about 210 bar, greater than or equal to about 170 bar to less than or equal to about 200 bar, or greater than or equal to about 180 bar to less than or equal to about 190 bar).

In at least one example embodiment, the contacting S1130 of the dry powder and the scenting material may include removing S1430 the supercritical carbon dioxide. The removing S1430 of the supercritical carbon dioxide may include evaporating the carbon dioxide. The carbon dioxide may be, and the method may include, recycling the carbon dioxide.

With renewed reference to FIG. 11, in at least one example embodiment, the method 1100 may include, following the contacting S1130 of the dry powder and the scenting material, separating S1140 the scenting material and the dry powder. In at least one example embodiment, the separating S1140 of the scenting material and the dry powder may include removing the scenting material from the dry powder. In at least one example embodiment, the separating S1140 of the scenting material and the dry powder may include removing the dry powder from the scenting material. In at least one example embodiment, the separating S1140 may include sifting the blend or mixture of the scenting material and the dry powder. In at least one example embodiment, the shifting may include moving the blend or mixture of the scenting material and the dry powder through a first mesh having a size US 40 and a second mesh having a size US 100.

In at least one example embodiment, the methods steps of method 1100 may be repeated until a desired or selected sensory attributes are achieved. For example, the dry powder as separated from the scenting material may be again contacted with a second scenting material. A second scenting material may be the same or different from the first scenting material. A second desired time period may be the same or different from the first desired time period. A second temperature of the second contacting may be the same as or different from the first temperature of the first contacting. In at least one example embodiment, the dry powder as separated from the scenting material following the earlier (e.g., first contacting) may be dried (i.e., prepared) before contacting with the second scenting material.

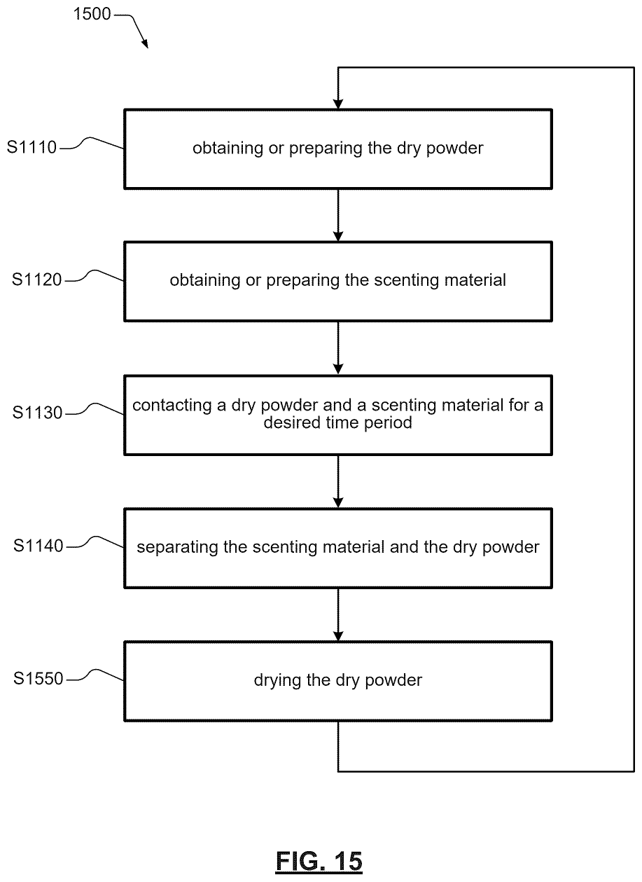

FIG. 15 is a flowchart illustrated another example method 1500 for modifying sensory attributes of an aerosol-forming substrate (e.g., aerosol-forming substrate 200 in FIG. 2 and/or aerosol-forming substrate 300 in FIG. 3 and/or aerosol-forming substrate 400 as illustrated in FIG. 4) that may be incorporated into a capsule (e.g., capsule 600 illustrated in FIG. 6) and/or received by an aerosol-generating device (e.g., like the aerosol-generating device 900 illustrated in FIG. 9) that may be configured to receive a capsule.

The method 1500 is the same as the method 1100 illustrated in FIG. 11 except that the method 1500 further includes drying S1550 the dry powder. In at least one example embodiment, the drying S1550 of the dry powder may include, for example, freeze drying. In at least one example embodiment, the drying S1550 of the dry powder may include air drying at low temperatures.

Although drying S1550 is illustrated as occurring after the separation S1140 of the scenting material and the dry powder, it should be appreciated that, in various example embodiments (including, for example, when the scenting material includes a cured material), the drying S1550 may occur before the separation S1140 of the scenting material and the dry powder.

While a number of example embodiments have been disclosed herein, it should be understood that other variations may be possible. Such variations are not to be regarded as a departure from the spirit and scope of the present inventive concepts, and all such modifications as would be obvious to one skilled in the art are intended to be included within the scope of the following claims.

Although described with reference to specific examples and drawings, modifications, additions and substitutions of example embodiments may be variously made according to the description by those of ordinary skill in the art. For example, the described techniques may be performed in an order different with that of the methods described, and/or elements such as the described system, architecture, devices, circuit, and the like, may be connected or combined to be different from the above-described methods, or results may be appropriately achieved by other elements or equivalents.

Illustrative embodiment 1. A method for modifying sensory attributes of an aerosol-forming substrate, the method comprising: contacting a dry powder and a scenting material for a desired time period.

Illustrative embodiment 2. The method of illustrative embodiment 1, wherein the scenting material includes mint, citrus, ginger root, cinnamon granules, vanilla beans, clove, anise, or any combination thereof.

Illustrative embodiment 3. The method of any of illustrative embodiments 1 and 2, wherein a mass ratio of the dry powder to the scenting material is greater than or equal to about 2:1 to less than or equal to about 1:2.

Illustrative embodiment 4. The method of any of illustrative embodiments 1-3,wherein the dry powder has a moisture content less than or equal to about 12%.

Illustrative embodiment 5. The method of any of illustrative embodiments 1-4, wherein the moisture content of the dry powder is greater than or equal to about 6%.

Illustrative embodiment 6. The method of any of illustrative embodiments 1-5, wherein the scenting material includes a fresh material, and the scenting material has a moisture content greater than or equal to about 60% to less than or equal to about 80%.

Illustrative embodiment 7. The method of illustrative embodiment 6, wherein the fresh material includes mint, citrus, ginger root, or any combination thereof.

Illustrative embodiment 8. The method of any of illustrative embodiments 6 and 7, wherein the desired time period is less than or equal to about 120 hours.

Illustrative embodiment 9. The method of any of illustrative embodiments 6-8, wherein the desired time period is about 48 hours.

Illustrative embodiment 10. The method of illustrative embodiment 6-9, wherein the contacting of the dry powder and the scenting material occurs at a temperature greater than or equal to about 20° C. to less than or equal to about 22° C.

Illustrative embodiment 11. The method of any of illustrative embodiments 6-9, wherein the contacting of the dry powder and the scenting material occurs at a temperature less than or equal to about 30° C.

Illustrative embodiment 12. The method of any of illustrative embodiments 1-5, wherein the scenting material includes a cured material, and the scenting material has a moisture content less than or equal to about 15%.

Illustrative embodiment 13. The method of illustrative embodiment 12, wherein the cured material includes cinnamon granules, vanilla beans, dried mint, clove, anise, or any combination thereof.

Illustrative embodiment 14. The method of any of illustrative embodiments 12 and 13, wherein the desired time period is greater than or equal to about 96 hours to less than or equal to about 120 hours.

Illustrative embodiment 15. The method of any of illustrative embodiment 12-14, wherein the contacting of the dry powder and the scenting material occurs at a temperature of greater than or equal to about 20° C. to less than or equal to about 40° C.

Illustrative embodiment 16. The method of any of illustrative embodiment 1-5, wherein the scenting material includes a natural scent source.

Illustrative embodiment 17. The method of illustrative embodiment 16, wherein the natural scent source includes mint leaves, vanilla pod, cinnamon granules, or any combination thereof.

Illustrative embodiment 18. The method of any of illustrative embodiment 1-17, wherein the contacting of the dry powder and the scenting material includes forming a layered structure, the layered structure includes a scenting material layer between first and second dry powder layers, the scenting material layer includes the scenting material, and each of the first and second dry powder layers includes the dry powder.

Illustrative embodiment 19. The method of illustrative embodiment 18, wherein the scenting material layer has an average thickness greater than or equal to about 5 millimeters to less than or equal to about 10 millimeters.

Illustrative embodiment 20. The method of any of illustrative embodiments 18 and 19, wherein at least one of the first and second dry powder layers has an average thickness greater than or equal to about 5 millimeters to less than or equal to about 10 millimeters.

Illustrative embodiment 21. The method of any of illustrative embodiments 18 and 19, wherein each of the first and second dry powder layers has an individual average thickness greater than or equal to about 5 millimeters to less than or equal to about 10 millimeters.

Illustrative embodiment 22. The method of any of illustrative embodiments 1-21, wherein the contacting of the dry powder and the scenting material includes: blending together the dry powder and the scenting material.

Illustrative embodiment 23. The method of any of illustrative embodiments 1-22, wherein the contacting of the dry powder and the scenting material includes: disposing at least one of the dry powder and the scenting material in a permeable bag.

Illustrative embodiment 24. The method of illustrative embodiment 23, wherein the scenting material includes mint leaves, cinnamon granules, or a combination of mint leaves and cinnamon granules.

Illustrative embodiment 25. The method of any of illustrative embodiments 1-24, wherein the contacting of the dry powder and the scenting material includes: adjusting temperature, pressure, humidity, or any combination thereof of the dry powder, the scenting material, or a combination of the dry powder and the scenting material.

Illustrative embodiment 26. The method of any of illustrative embodiments 1-25, wherein the method further comprises: separating the scenting material and the dry powder.

Illustrative embodiment 27. The method of illustrative embodiment 26, wherein the separating of the scenting material and the dry powder includes sifting the dry powder.

Illustrative embodiment 28. The method of any of illustrative embodiments 1-27, wherein the method further comprises: drying the dry powder, the dry powder having a moisture content of less than or equal to about 15%.

Illustrative embodiment 29. The method of any of illustrative embodiment 1-28, wherein the contacting of the dry powder and the scenting material is a first contacting, the scenting material is a first scenting material, the desired time period is a first desired time period, and the method further comprises: second contacting the dry powder and a second scenting material for a second desired time period.

Illustrative embodiment 30. The method of illustrative embodiment 29, wherein between the first contacting and the second contacting, the method further comprises: drying the dry powder to have a moisture content of less than or equal to about 30%.

Illustrative embodiment 31. The method of illustrative embodiment 30, wherein the second scenting material is the same as the first scenting material.

Illustrative embodiment 32. The method of illustrative embodiment 30, wherein the second scenting material is different from the first scenting material.

Illustrative embodiment 33. The method of illustrative embodiment 30, wherein the second desired time period is the same as the first desired time period.

Illustrative embodiment 34. The method of illustrative embodiment 30, wherein the second desired time period is different from the first desired time period.

Illustrative embodiment 35. The method of any of illustrative embodiments 30-34, wherein the dry powder includes tobacco.

Illustrative embodiment 36. A method for modifying sensory attributes of an aerosol-forming substrate, the method comprising: contacting a dry powder and a scenting material for a desired time period.

Illustrative embodiment 37. The method of illustrative embodiment 36, wherein the scenting material includes mint, citrus, ginger root, cinnamon granules, vanilla beans, clove, anise, or any combination thereof.

Illustrative embodiment 38. The method of any of illustrative embodiments 36 and 37, wherein a mass ratio of the dry powder to the scenting material is greater than or equal to about 2:1 to less than or equal to about 1:2.

Illustrative embodiment 39. The method of any of illustrative embodiments 36-38, wherein the dry powder has a moisture content greater than or equal to about 6% to less than or equal to about 12%.

Illustrative embodiment 40. The method of any of illustrative embodiments 36-39, wherein the scenting material includes a fresh material, and the scenting material has a moisture content greater than or equal to about 60% to less than or equal to about 80%.

Illustrative embodiment 41. The method of illustrative embodiment 40, wherein the fresh material includes mint, citrus, ginger root, or any combination thereof.

Illustrative embodiment 42. The method of any of illustrative embodiments 40 and 42, wherein the contacting of the dry powder and the scenting material occurs at a temperature greater than or equal to about 20° C. to less than or equal to about 30° C.

Illustrative embodiment 43. The method of any of illustrative embodiment 36-39, wherein the scenting material includes a cured material, and the scenting material has a moisture content less than or equal to about 15%.

Illustrative embodiment 44. The method of illustrative embodiment 43, wherein the desired time period is greater than or equal to about 96 hours to less than or equal to about 120 hours.

Illustrative embodiment 45. The method of any of illustrative embodiments 43 and 44, wherein the contacting of the dry powder and the scenting material occurs at a temperature of greater than or equal to about 20° C. to less than or equal to about 40° C.

Illustrative embodiment 46. The method of any of illustrative embodiments 36-45, wherein the scenting material includes a natural scent source.

Illustrative embodiment 47. The method of any of illustrative embodiments 36-46, wherein the contacting of the dry powder and the scenting material includes forming a layered structure, the layered structure includes a scenting material layer between first and second dry powder layers, the scenting material layer includes the scenting material, and each of the first and second dry powder layers includes the dry powder.

Illustrative embodiment 48. The method of illustrative embodiment 47, wherein the scenting material layer has an average thickness greater than or equal to about 5 millimeters to less than or equal to about 10 millimeters, and at least one of the first and second dry powder layers has an average thickness greater than or equal to about 5 millimeters to less than or equal to about 10 millimeters.

Illustrative embodiment 49. The method of any of illustrative embodiments 36-48, wherein the contacting of the dry powder and the scenting material includes: blending together the dry powder and the scenting material.

Illustrative embodiment 50. The method of any of illustrative embodiments 36-49, wherein the contacting of the dry powder and the scenting material includes: disposing at least one of the dry powder and the scenting material in a permeable bag.

Illustrative embodiment 51. The method of any of illustrative embodiments 36-50, wherein the contacting of the dry powder and the scenting material includes: adjusting temperature, pressure, humidity, or any combination thereof of the dry powder, the scenting material, or a combination of the dry powder and the scenting material.

Illustrative embodiment 52. The method of any of illustrative embodiments 36-51, wherein the method further comprises: separating the scenting material and the dry powder.

Illustrative embodiment 53. The method of any of illustrative embodiments 36-52, wherein the method further comprises: drying the dry powder, the dry powder having a moisture content of less than or equal to about 15%.

Illustrative embodiment 54. The method of any of illustrative embodiments 36-53, wherein the contacting of the dry powder and the scenting material is a first contacting, the scenting material is a first scenting material, the desired time period is a first desired time period, and the method further comprises: second contacting the dry powder and a second scenting material for a second desired time period.

Illustrative embodiment 55. The method of any of illustrative embodiments 54, wherein between the first contacting and the second contacting, the method further comprises: drying the dry powder to have a moisture content of less than or equal to about 30%.

What is claimed is:

1. A method for modifying sensory attributes of an aerosol-forming substrate, the method comprising:
contacting a dry powder and a scenting material for a desired time period.

2. The method of claim 1, wherein the scenting material includes mint, citrus, ginger root, cinnamon granules, vanilla beans, clove, anise, or any combination thereof.

3. The method of claim 1, wherein a mass ratio of the dry powder to the scenting material is greater than or equal to about 2:1 to less than or equal to about 1:2.

4. The method of claim 1, wherein the dry powder has a moisture content greater than or equal to about 6% to less than or equal to about 12%.

5. The method of claim 1, wherein
the scenting material includes a fresh material, and
the scenting material has a moisture content greater than or equal to about 60% to less than or equal to about 80%.

6. The method of claim 5, wherein the fresh material includes mint, citrus, ginger root, or any combination thereof.

7. The method of claim 5, wherein the contacting of the dry powder and the scenting material occurs at a temperature greater than or equal to about 20° C. to less than or equal to about 30° C.

8. The method of claim 1, wherein
the scenting material includes a cured material, and
the scenting material has a moisture content less than or equal to about 15%.

9. The method of claim 8, wherein the desired time period is greater than or equal to about 96 hours to less than or equal to about 120 hours.

10. The method of claim 9, wherein the contacting of the dry powder and the scenting material occurs at a temperature of greater than or equal to about 20° C. to less than or equal to about 40° C.

11. The method of claim 1, wherein the scenting material includes a natural scent source.

12. The method of claim 1, wherein
the contacting of the dry powder and the scenting material includes forming a layered structure,
the layered structure includes a scenting material layer between first and second dry powder layers,
the scenting material layer includes the scenting material, and
each of the first and second dry powder layers includes the dry powder.

13. The method of claim 12, wherein
the scenting material layer has an average thickness greater than or equal to about 5 millimeters to less than or equal to about 10 millimeters, and
at least one of the first and second dry powder layers has an average thickness greater than or equal to about 5 millimeters to less than or equal to about 10 millimeters.

14. The method of claim 1, wherein the contacting of the dry powder and the scenting material includes:
blending together the dry powder and the scenting material.

15. The method of claim 1, wherein the contacting of the dry powder and the scenting material includes:
disposing at least one of the dry powder and the scenting material in a permeable bag.

16. The method of claim 1, wherein the contacting of the dry powder and the scenting material includes:
adjusting temperature, pressure, humidity, or any combination thereof of the dry powder, the scenting material, or a combination of the dry powder and the scenting material.

17. The method of claim 1, wherein the method further comprises:
separating the scenting material and the dry powder.

18. The method of claim 1, wherein the method further comprises:
drying the dry powder, the dry powder having a moisture content of less than or equal to about 15%.

19. The method of claim 1, wherein the contacting of the dry powder and the scenting material is a first contacting, the scenting material is a first scenting material, the desired time period is a first desired time period, and the method further comprises:
second contacting the dry powder and a second scenting material for a second desired time period.

20. The method of claim 19, wherein between the first contacting and the second contacting, the method further comprises:
drying the dry powder to have a moisture content of less than or equal to about 30%.
